(19) United States
(12) Patent Application Publication
(10) Pub. No.: US 2011/0051976 A1
(43) Pub. Date: Mar. 3, 2011

(54) HEADPHONE

(76) Inventor: Jonson Tsai, Taipei (TW)

(21) Appl. No.: 12/624,615

(22) Filed: Nov. 24, 2009

(30) Foreign Application Priority Data
Aug. 25, 2009 (TW) 098215672

(51) Int. Cl. H04R 1/10

(52) U.S. Cl. 381/378

(57) ABSTRACT

A headphone includes a headband, a pivot joint, and an ear cup. The pivot joint includes a first rod that is coupled rotatably to the headband and that defines a first axis, a second rod that defines a second axis, and an intermediate rod that interconnects the first and second rods. The pivot joint is rotatable relative to the headband about the first axis. The ear cup is coupled rotatably to the second rod of the pivot joint, and is rotatable relative to the pivot joint about the second axis.

### CROSS-REFERENCE TO RELATED APPLICATION

This application claims priority of Taiwanese application no. 098215672, filed on Aug. 25, 2009.

### BACKGROUND OF THE INVENTION

1. Field of the Invention

This invention relates to a headphone.

2. Description of the Related Art

A conventional headphone, such as that disclosed in Taiwanese Utility Model Publication No. M326307, includes a headband, first and second pivot joints, and first and second ear cups. The headband includes left and right frames, and an intermediate frame. Each of the first and second pivot joints includes a seat and a post. The seat of the first pivot joint is coupled rotatably to an end of the intermediate frame of the headband and is formed with a groove. The post of the first pivot joint is formed on an end of the left frame of the headband, extends into the groove in the seat of the first pivot joint, and is coupled rotatably to the seat of the first pivot joint with the use of a screw, thereby permitting rotation of the left frame of the headband relative to the seat of the first pivot joint. The seat of the second pivot joint is coupled rotatably to another end of the intermediate frame of the headband and is formed with a groove. The post of the second pivot joint is formed on an end of the right frame of the headband, extends into the groove in the seat of the second pivot joint, and is coupled rotatably to the seat of the second pivot joint with the use of a screw, thereby permitting rotation of the right frame of the headband relative to the seat of the second pivot joint. Each of the first and second ear cups is coupled to a respective one of the left and right frames of the headband.

The aforementioned conventional headphone is disadvantageous in that the seat and the post of each of the first and second pivot joints are made from plastic and therefore wear easily.

### SUMMARY OF THE INVENTION

Therefore, the object of the present invention is to provide a headphone that can overcome the aforesaid drawback of the prior art.

According to the present invention, a headphone comprises a headband, a pivot joint, and an ear cup. The pivot joint includes a first rod that is coupled rotatably to the headband and that defines a first axis, a second rod that defines a second axis, and an intermediate rod that interconnects the first and second rods. The pivot joint is rotatable relative to the headband about the first axis. The ear cup is coupled rotatably to the second rod of the pivot joint, and is rotatable relative to the pivot joint about the second axis.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of the preferred embodiment of a headphone according to this invention;

FIG. 2 is an exploded perspective view illustrating a left frame of a headband, a first pivot joint, and a first ear cup of the preferred embodiment;

FIG. 3 is an exploded perspective view illustrating a right frame of the headband, a second pivot joint, and a second ear cup of the preferred embodiment;

FIG. 4 is a partial sectional view illustrating left frame of the headband, the first pivot joint, and the first ear cup of the preferred embodiment in an assembled state;

FIG. 5 is a perspective view illustrating a transmission wire unit and the first/second pivot joint of the preferred embodiment in an assembled state;

FIG. 6 is a sectional view of the preferred embodiment in an assembled state;

FIG. 7 is a schematic view illustrating a shell of the first/second ear cups of the preferred embodiment;

FIGS. 8 and 9 are sectional views illustrating assembling of the first/second pivot joint on the first/second ear cup of the preferred embodiment;

FIGS. 10 and 11 are schematic view illustrating assembling of the first/second pivot joint on the first/second ear cup of the preferred embodiment;

FIG. 12 is a perspective view illustrating a first rod of the first/second pivot joint of the preferred embodiment;

FIG. 13 is a perspective view illustrating an abutting piece of the first/second ear cup of the preferred embodiment;

FIG. 14 is a perspective view of a modified first/second pivot joint of the preferred embodiment;

FIG. 15 is an exploded perspective view of the modified first/second pivot joint of the preferred embodiment in FIG. 14;

FIG. 16 is a perspective view of another modified first/second pivot joint of the preferred embodiment;

FIGS. 17 and 18 are sectional views illustrating the first and second ear cups when rotated relative to the first and second pivot joints of the preferred embodiment, respectively;

FIG. 19 is a schematic view of the preferred embodiment illustrating the first and second ear cups when rotated to a rear side of the headband; and

FIG. 20 is a partial sectional view of the preferred embodiment taken on line 20--20 of FIG. 19.

### DETAILED DESCRIPTION OF THE PREFERRED EMBODIMENT

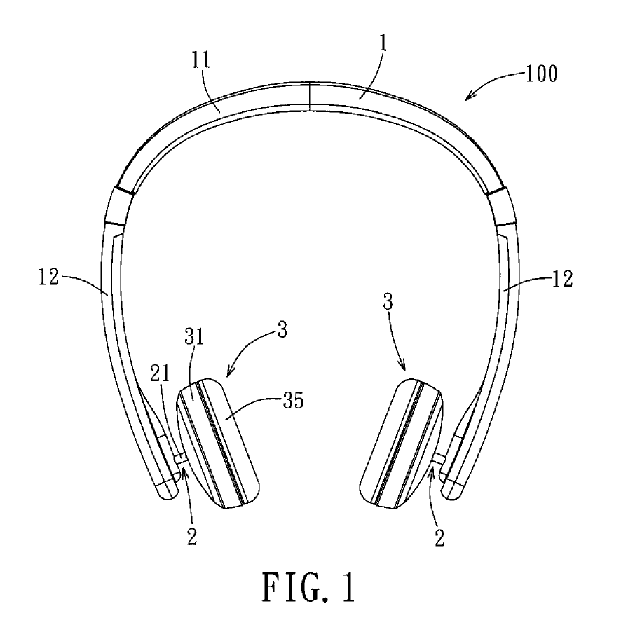

Referring to FIG. 1, the preferred embodiment of a headphone 100 according to this invention is shown to include a headband 1, first and second pivot joints 2, and first and second ear cups 3.

The headphone 100 converts electric signals into sounds.

The first and second ear cups 3 are held in place over the user's ears by the headband 1.

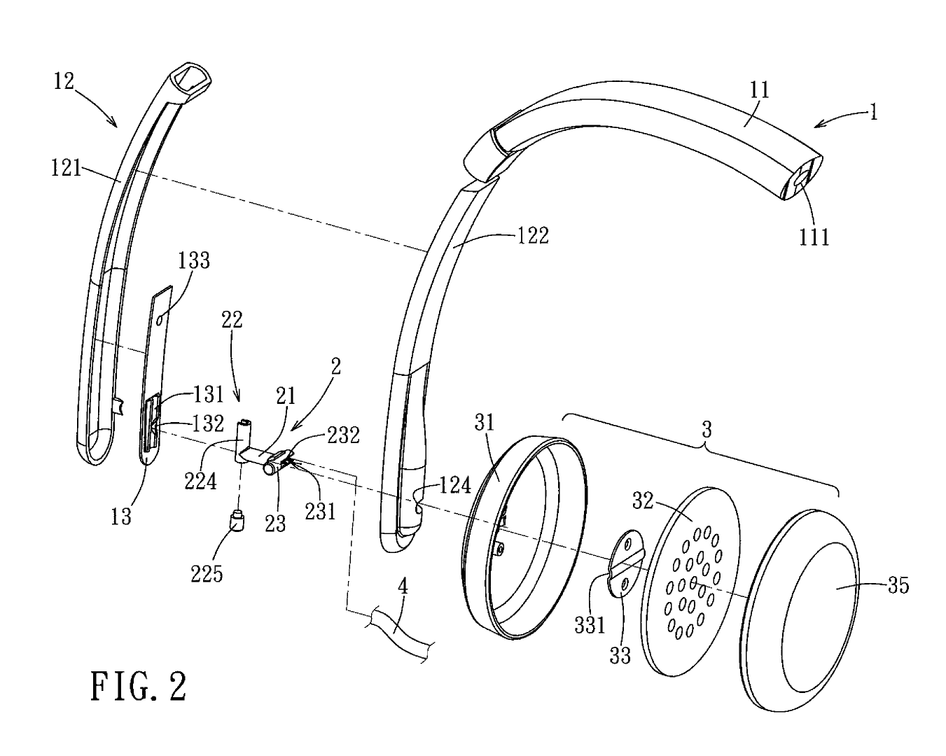

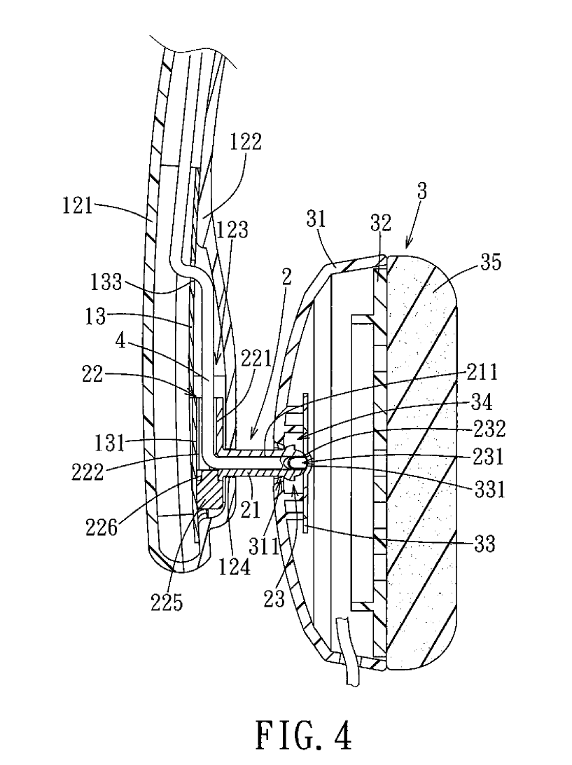

The headband 1 is generally C-shaped, and includes left and right frames 12, and an intermediate frame 11 that interconnects the left and right frames 12 thereof. As illustrated in FIGS. 2, 4, and 6, the left frame 12 of the headband 1 includes outer and inner shells 121, 122. The inner shell 122 of the left frame 12 of the headband 1 is fastened on the outer shell 121 of the left frame 12 of the headband 1 with the use of a screw (not shown). The outer and inner shells 121, 122 of the left frame 12 of the headband 1 cooperatively define a receiving space 123 therebetween. The inner shell 122 of the left frame 12 of the headband 1 has front and read sides, and an inner side that interconnects the front and read sides thereof. The inner shell 122 of the left frame 12 of the headband 1 is formed with a guide hole 124 therethrough that is in spatial communication with the receiving space 123 in the left frame 12 of the headband 1 and that extends from the inner side to the rear side thereof.

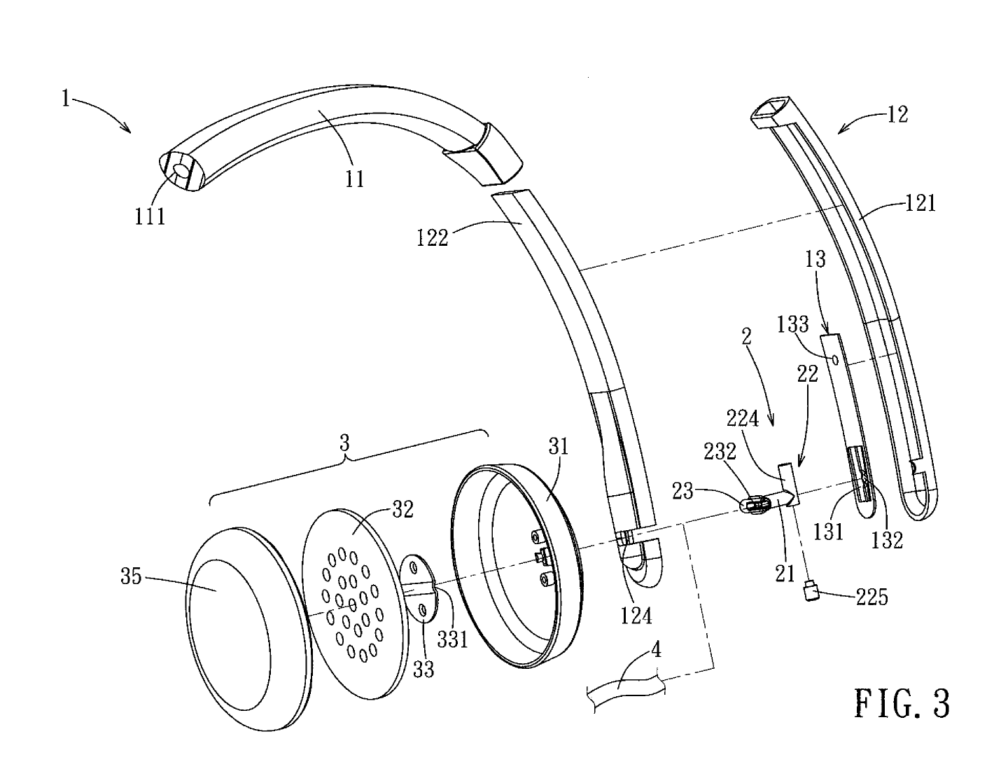

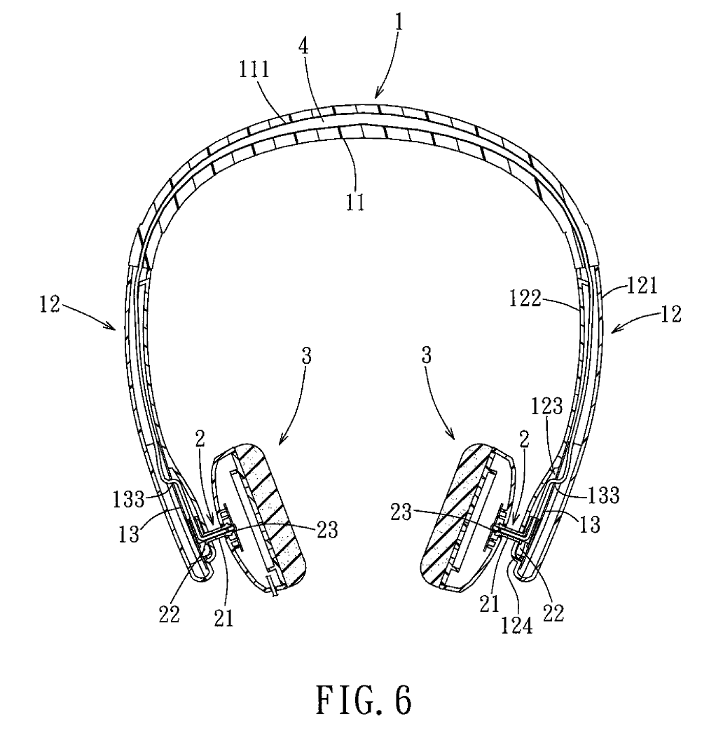

As illustrated in FIGS. 3 and 6, the right frame 12 of the headband 1 includes outer and inner shells 121, 122. The inner shell 122 of the right frame 12 of the headband 1 is fastened on the outer shell 121 of the right frame 12 of the headband 1 with the use of a screw (not shown). The outer and inner shells 121, 122 of the right frame 12 of the headband 1 cooperatively define a receiving space 123 therebetween. The inner shell 122 of the right frame 12 of the headband 1 has front and read sides, and an inner side that interconnects the front and read sides thereof. The inner shell 122 of the right frame 12 of the headband 1 is formed with a guide hole 124 therethrough that is in spatial communication with the receiving space 123 in the right frame 12 of the headband 1 and that extends from the inner side to the rear side thereof.

The headband 1 further includes left and right abutting pieces 13. The left abutting piece 13 of the headband 1 is disposed in the receiving space 123 in the left frame 12 of the headband 1, and has opposite ends that are fastened on the inner shell 122 of the left frame 12 of the headband 1 with the use of a pair of screws (not shown). The right abutting piece 13 of the headband 1 is disposed in the receiving space 123 in the right frame 12 of the headband 1, and has opposite ends that are fastened on the inner shell 122 of the right frame 12 of the headband 1 with the use of a pair of screws (not shown).

The first pivot joint 2 includes first and second rods 22, 23, and an intermediate rod 21 that interconnects the first and second rods 22, 23 thereof. The first and second rods 22, 23 and the intermediate rod 21 of the first pivot joint 2 are transverse to each other. The first rod 22 and the intermediate rod 21 of the first pivot joint 2 form a T-shape. Likewise, the second rod 23 and the intermediate rod 21 of the first pivot joint 2 form a T-shape. The first rod 22 of the first pivot joint 2 is disposed in the receiving space 123 in the left frame 12 of the headband 1, abuts against the left abutting piece 13 of the headband 1, and defines a first axis. The intermediate rod 21 of the first pivot joint 2 extends into the guide hole 124 in the inner shell 122 of the left frame 12 of the headband 1. The construction as such permits rotation of the first pivot joint 2 relative to the headband 1 about the first axis.

In this embodiment, the left abutting piece 13 of the headband 1 has an arcuate surface 131. The first rod 22 of the first pivot joint 2 abuts against the arcuate surface 131 of the left abutting piece 13 of the headband 1. This facilitates smooth rotation of the first pivot joint 2 about the first axis and prevents the first pivot joint 2 from wobbling.

The first ear cup 3 includes a shell 31, and a cover 32 mounted on the shell 31 thereof. The shell 31 and the cover 32 of the first ear cup 3 cooperatively define a receiving space 34 therebetween for receiving a left speaker (not shown) and electronic components (not shown). The first ear cup 3 further includes an abutting piece 33 disposed in the receiving space 34 therein and fastened on the shell 31 thereof with the use of screws (not shown). The shell 31 of the first ear cup 3 is formed with a guide hole 311 therethrough that is in spatial communication with the receiving space 34 in the first ear cup 3.

The second rod 23 of the first pivot joint 2 is disposed in the receiving space 34 in the first ear cup 3, abuts against the abutting piece 33 of the first ear cup 3, and defines a second axis. The intermediate rod 21 of the first pivot joint 2 extends into the guide hole 311 in the shell 31 of the first ear cup 3. The construction as such permits rotation of the first ear cup 3 relative to the first pivot joint 2 about the second axis.

In this embodiment, the abutting piece 33 of the first ear cup 3 has an arcuate surface 331. The second rod 23 of the first pivot joint 2 abuts against the arcuate surface 331 of the abutting piece 33 of the first ear cup 3. This facilitates smooth rotation of the first ear cup 3 about the second axis and prevents the first ear cup 3 from wobbling.

The second pivot joint 2 includes first and second rods 22, 23, and an intermediate rod 21 that interconnects the first and second rods 22, 23 thereof. The first and second rods 22, 23 and the intermediate rod 21 of the second pivot joint 2 are transverse to each other. The first rod 22 and the intermediate rod 21 of the second pivot joint 2 form a T-shape. Likewise, the second rod 23 and the intermediate rod 21 of the second pivot joint 2 form a T-shape. The first rod 22 of the second pivot joint 2 is disposed in the receiving space 123 in the right frame 12 of the headband 1, abuts against the right abutting piece 13 of the headband 1, and defines a third axis. The intermediate rod 21 of the second pivot joint 2 extends into the guide hole 124 in the inner shell 122 of the right frame 12 of the headband 1. The construction as such permits rotation of the second pivot joint 2 relative to the headband 1 about the third axis.

In this embodiment, the right abutting piece 13 of the headband 1 has an arcuate surface 131. The first rod 22 of the second pivot joint 2 abuts against the arcuate surface 131 of the right abutting piece 13 of the headband 1. This facilitates smooth rotation of the second pivot joint 2 about the third axis and prevents the second pivot joint 2 from wobbling.

The second ear cup 3 includes a shell 31, and a cover 32 mounted on the shell 31 thereof. The shell 31 and the cover 32 of the second ear cup 3 cooperatively define a receiving space 34 therebetween for receiving a right speaker (not shown) and electronic components (not shown). The second ear cup 3 further includes an abutting piece 33 disposed in the receiving space 34 therein and fastened on the shell 31 thereof with the use of screws (not shown). The shell 31 of the second ear cup 3 is formed with a guide hole 311 therethrough that is in spatial communication with the receiving space 34 in the second ear cup 3.

The second rod 23 of the second pivot joint 2 is disposed in the receiving space 34 in the second ear cup 3, abuts against the abutting piece 33 of the second ear cup 3, and defines a fourth axis. The intermediate rod 21 of the second pivot joint 2 extends into the guide hole 311 in the shell 31 of the second ear cup 3. The construction as such permits rotation of the second ear cup 3 relative to the second pivot joint 2 about the fourth axis.

In this embodiment, the abutting piece 33 of the second ear cup 3 has an arcuate surface 331. The second rod 23 of the second pivot joint 2 abuts against the arcuate surface 331 of the abutting piece 33 of the second ear cup 3. This facilitates smooth rotation of the second ear cup 3 about the fourth axis and prevents the second ear cup 3 from wobbling.

Each of the first and second ear cups 3 further includes an ear cup cushion 35 provided on the cover 32 thereof for making the headphone 100 more comfortable to use.

In this embodiment, the first and second pivot joints 2, the left and right abutting pieces 13 of the headband 1, and the abutting pieces 33 of the first and second ear cups 3 are made from metal. As such, wearing of the first and second pivot joints 2, the left and right abutting pieces 13 of the headband 1, and the abutting pieces 33 of the first and second ear cups 3 due to repetitive rotations of the first and second pivot joints 2 and the first and second ear cups 3 can be prevented.

It is noted that each of the first and second pivot joints 2 is hollow. That is, each of the first and second rods 22, 23 and the intermediate rod 21 of each of the first and second pivot joints 2 defines an axially extending channel 221, 231, 211.

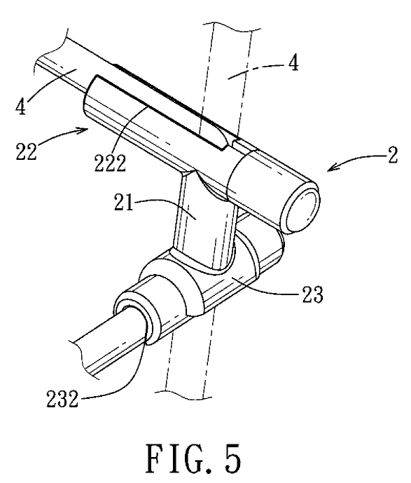

With further reference to FIG. 5, the headphone 100 further includes a transmission wire unit 4 that extends through the shell 31 of the first ear cup 3, the channel 221, 231, 211 in each of the first and second rods 22, 23 and the intermediate rod 21 of the first pivot joint 2, a through-hole 133 in the left abutting piece 13 of the headband 1, a channel 111 in the intermediate frame 11 of the headband 1, a through-hole 133 in the right abutting piece 13 of the headband 1, and the channel 221, 231, 211 in each of the first and second rods 22, 23 and the intermediate rod 21 of the second pivot joint 2. The transmission wire unit 4 has a first end connected to the right speaker in the second ear cup 3.

The headphone 100 further includes a second transmission wire unit (not shown) that extends into the shell 31 of the first ear cup 3 and that has a first end connected to the speaker in the first ear cup 3.

Each of the transmission wire unit 4 and the second transmission wire unit further has a second end connected to a signal source (not shown), such as a computer or a portable player, for transmission of signals from the signal source to the left and right speakers.

When it is desired to assemble the transmission wire unit 4 on the headphone 100, the first end of the transmission wire unit 4 is first passed through the shell 31 of the first ear cup 3, the channel 211 in the intermediate rod 21 of the first pivot joint 2, the through-hole 133 in the left abutting piece 13 of the headband 1, the channel 111 in the intermediate frame 11 of the headband 1, the hole 133 in the right abutting piece 13 of the headband 1, and the channel 211 in the intermediate rod 21 of the second pivot joint 2. Then, the transmission wire unit 4 is squeezed into the channel 221 in the first rod 22 of the first pivot joint 2 through an opening 222 in the first rod 22 of the first pivot joint 2, and the channel 231 in the second rod 23 of the first pivot joint 2 through an opening 232 in the second rod 23 of the first pivot joint 2. Thereafter, the transmission wire unit 4 is squeezed into the channel 221 in the first rod 22 of the second pivot joint 2 through an opening 222 in the first rod 22 of the second pivot joint 2, and the channel 231 in the second rod 23 of the second pivot joint 2 through an opening 232 in the second rod 23 of the second pivot joint 2.

It is noted that since the transmission wire unit 4 extends through the channels 211 in the intermediate rods 21 of the first and second pivot joints 2, the transmission wire unit 4 is not exposed at a junction of the left frame 12 of the headband 1 and the first ear cup 3 and a junction of the right frame 12 of the headband 1 and the second ear cup 3, and is prevented from being tangled or pulled when the first or second ear cups 3 are rotated. Moreover, since the transmission wire unit 4 extends through the first and second rods 22, 23 of the first and second pivot joints 2, bends in the transmission wire unit 4 is protected from being accidentally pressed, which may result in a short circuit or a signal transmission error.

In an alternative embodiment, the channels 221 in the first rods 22 of the first and second pivot joints 2 are dispensed with. In this case, the arcuate surface 131 of each of the left and right abutting pieces 13 of the headband 1 defines a channel for extension of the transmission wire unit 4 therethrough.

The first rod 22 of each of the first and second pivot joints 2 includes a first rod portion 224 formed on the intermediate rod 21 of a respective one of the first and second pivot joints 2, and a second rod portion 225 fastened to the first rod portion 224 thereof.

The first rod portion 224 of the first rod 22 of the first pivot joint 2 defines the channel 221 and is formed with the opening 222, and is further formed with an engaging groove 226. In this embodiment, the first rod portion 224 of the first rod 22 of the first pivot joint 2 has a size less than that of the guide hole 311 in the shell 31 of the first ear cup 3. The second rod portion 225 of the first rod 22 of the first pivot joint 2 extends into the engaging groove 226 in the first rod portion 224 of the first rod 22 of the first pivot joint 2. The first and second rod portions 224, 225 of the first rod 22 of the first pivot joint 2 have a total size larger than that of the guide hole 311 in the shell 31 of the first ear cup 3.

The first rod portion 224 of the first rod of the second pivot joint 2 defines the channel 221 and is formed with the opening 222, and is further formed with an engaging groove 226. In this embodiment, the first rod portion 224 of the first rod 22 of the second pivot joint 2 has a size less than that of the guide hole 311 in the shell 31 of the second ear cup 3. The second rod portion 225 of the first rod 22 of the second pivot joint 2 extends into the engaging groove 226 in the first rod portion 224 of the first rod 22 of the second pivot joint 2. The first and second rod portions 224 of the first rod 22 of the second pivot joint 2 has a total size larger than that of the guide hole 311 in the shell 31 of the second ear cup 3.

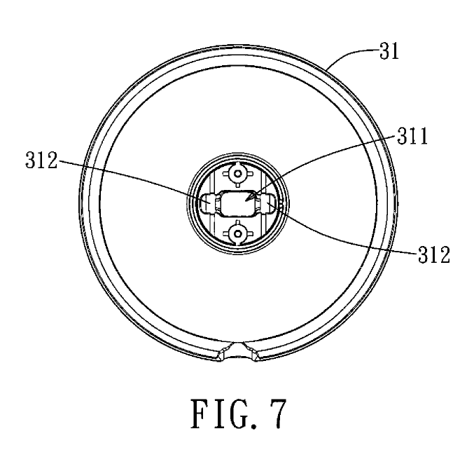

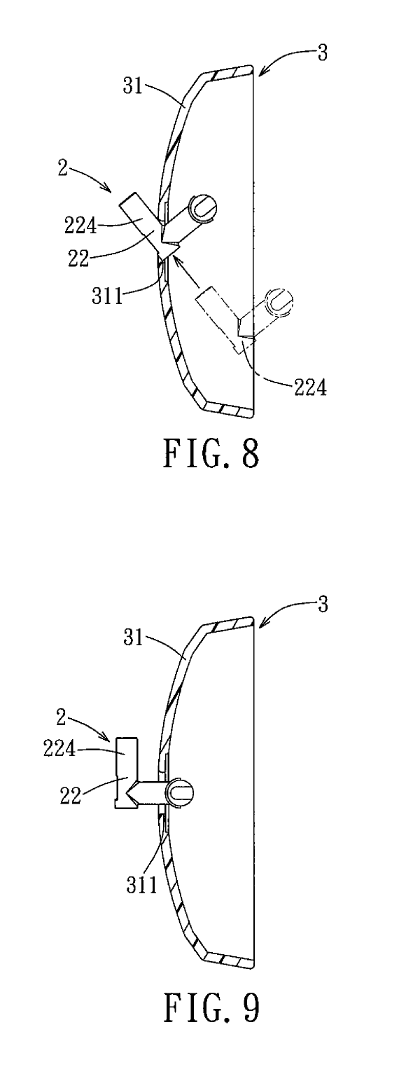

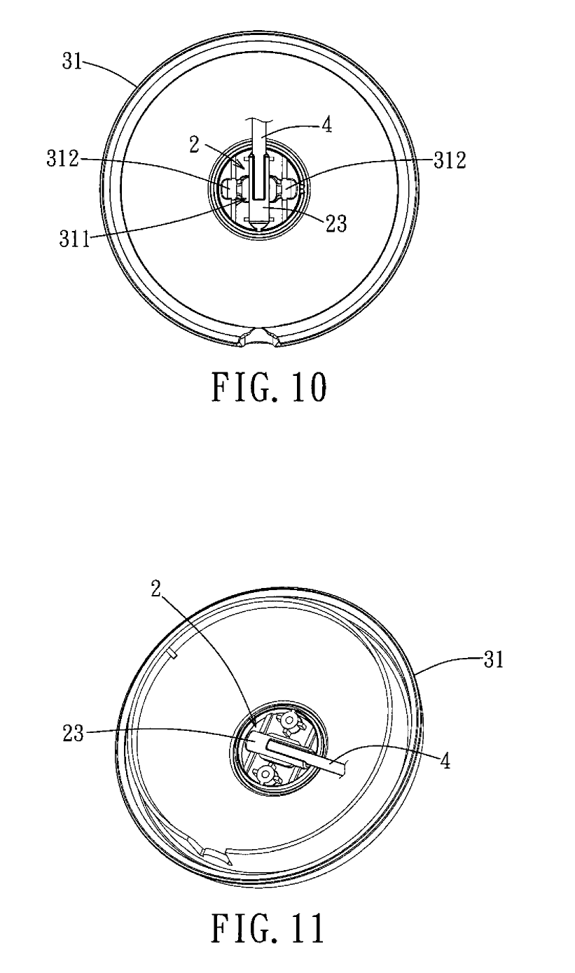

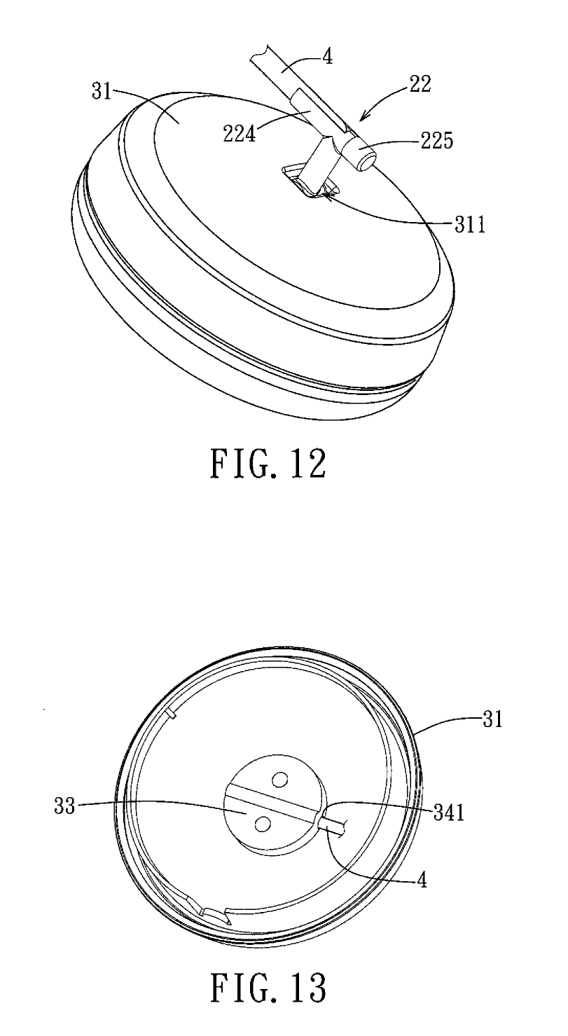

When it is desired to assemble the first and second pivot joints 2 on the first and second ear cups 3, respectively, as illustrated in FIGS. 8 and 9, the first rod portion 224 of the first rod 22 is first inserted through the guide hole 311 in the shell 31. Then, as illustrated in FIGS. 7, 10 and 11, the second rod 23 is engaged to a pair of engaging grooves 312 in an inner surface of the shell 31. Subsequently, as illustrated in FIG. 12, the second rod portion 225 of the first rod 22 is inserted into the engaging groove 226 in the first rod portion 224 of the first rod 22. Thereafter, as illustrated in FIG. 13, the abutting piece 33 is fastened on the shell 31, and the transmission wire unit 4 is inserted through a through-hole 341 in the shell 31.

In this embodiment, the second rod portion 225 is fastened to the first rod portion 224 using an adhesive (not shown).

In an alternative embodiment, the second rod portion 225 is fastened to the first rod portion 224 using a rivet (not shown).

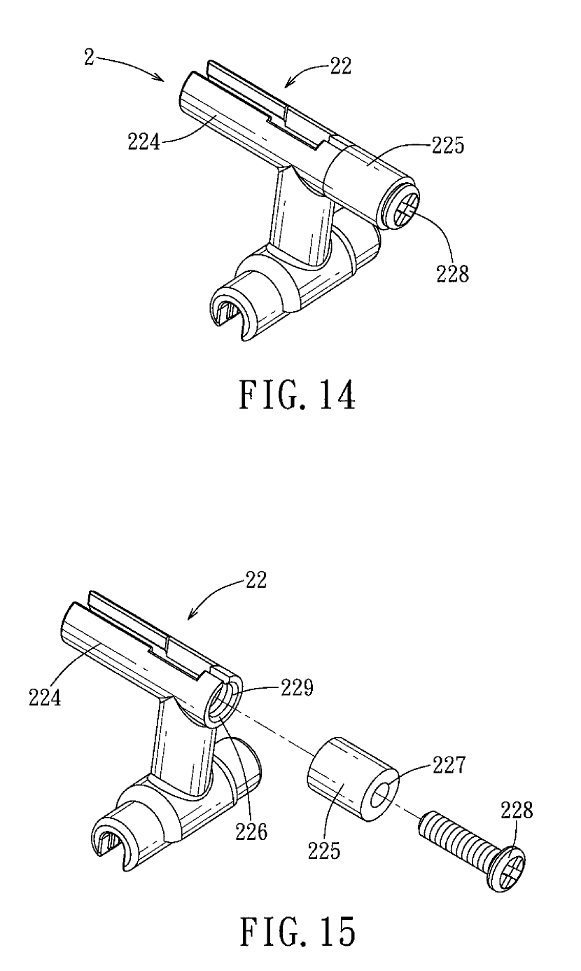

In yet another embodiment, as illustrated in FIG. 14, the second rod portion 225 is fastened to the first rod portion 224 using a screw 228. In particular, as illustrated in FIG. 15, the engaging groove 226 in the first rod portion 224 is defined by a hole-defining wall formed with a thread 229. The second rod portion 225 is formed with a through-hole 227. The screw 228 extends through the through-hole 227 in the second rod portion 225 and engages threadedly the thread 229 on the hole-defining wall of the first rod portion 224.

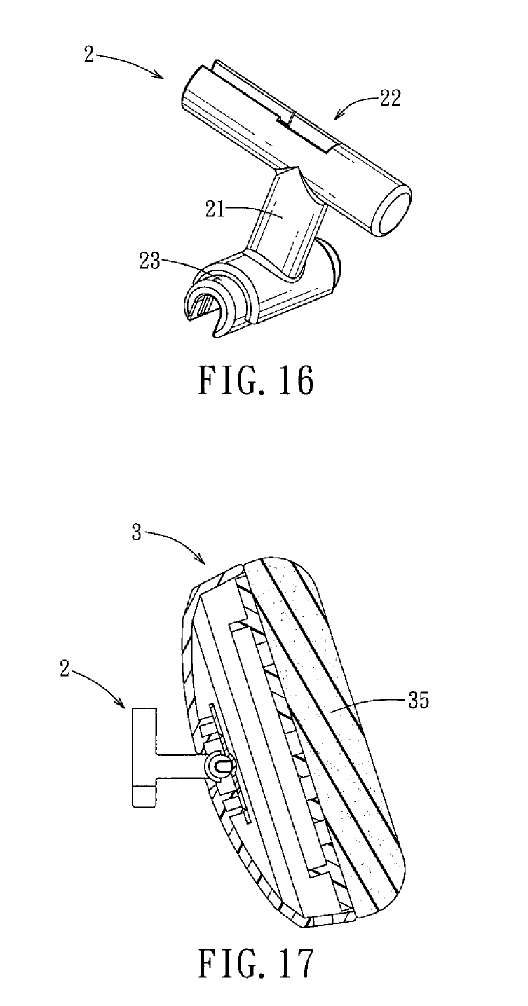

It is noted that, as illustrated in FIG. 16, the first rod 22 and the intermediate rod 21 may be formed in one piece. In this case, the length of the first rod 22 may be made shorter than that of the guide hole 311 in the shell 31 or the length of the guide hole 311 may be made longer than that of the first rod 22.

When it is desired to assemble the first and second pivot joints 2 on the headband 1, the first rod 22 is first inserted into the receiving space 123 in a respective one of the left and right frames 12 of the headband 1 through the guide hole 124 in the inner shell 122 of the respective one of the left and right frames 12 of the headband 1. Then, each of the left and right abutting pieces 13 is fastened on the inner shell 122 of the respective one of the left and right frames 12. Thereafter, the inner shell 122 of each of the left and right frames 12 of the headband 1 is fastened on the outer shell 122 of the respective one of the left and right frames 12 of the headband 1.

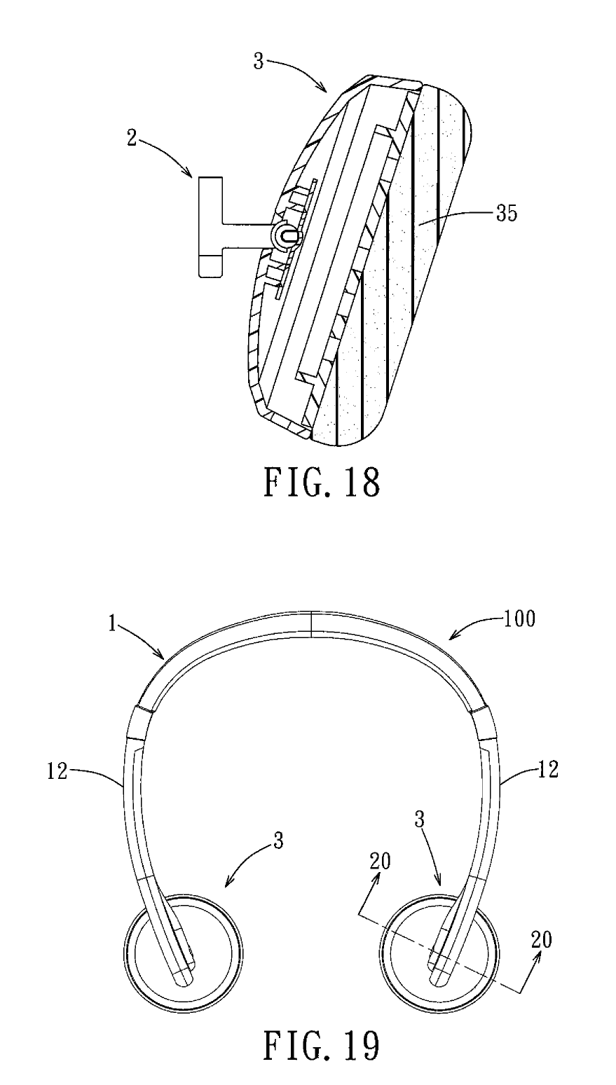

As illustrated in FIGS. 17 and 18, when the headphone 100 is worn by the user, since the first and second pivot joints 2 are rotatable relative to the headband 1, and since the first and second ear cups 3 are rotatable relative to the first and second pivot joints 2, respectively, the first and second ear cups 3 align correctly with the ears of the users.

The arcuate surface 131 of each of the left and right abutting pieces 13 of the headband 1 is formed with a receiving groove 132 (see FIGS. 2 and 3).

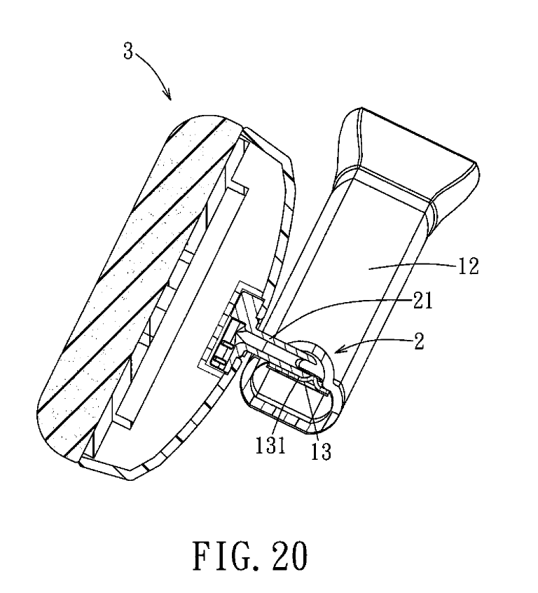

When the headphone 100 is not in use, as illustrated in FIGS. 19 and 20, the first and second ear cups 3 may be rotated to a rear side of the headband 1 such that the intermediate rods 21 of the first and second pivot joints 2 are received in the receiving grooves 132 in the arcuate surfaces 131 of the left and right abutting pieces 13 of the headband 1, respectively, thereby minimizing space occupied by the headphone 100.

It is noted that the intermediate rod 21 of each of the first and second pivot joints 2 is disposed at a position between opposite ends of the first rod 22 of a respective one of the first and second pivot joints 2. As such, when each of the first and second pivot joints 2 are rotated relative to the headband 1 via a respective one of the first and second ear cups 3, the force exerted on each of the first and second pivot joints can be uniformly transmitted to the arcuate surface 131 of a respective one of the left and right abutting pieces 13 of the headband 1. This results in smoother and more stable rotations of the first and second pivot joints 2.

In an alternative embodiment, the headphone 100 includes only the first pivot joint 2 and the first ear cup 3.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A headphone comprising:
a headband;
a pivot joint including a first rod that is coupled rotatably to said headband and that defines a first axis,
a second rod that defines a second axis, and
an intermediate rod that interconnects said first and second rods, said pivot joint being rotatable relative to said headband about the first axis; and
an ear cup coupled rotatably to said second rod of said pivot joint, and rotatable relative to said pivot joint about the second axis.

2. The headphone as claimed in claim 1, wherein said headband defines a receiving space, and is formed with a guide hole therethrough that is in spatial communication with said receiving space in said headband, said first rod of said pivot joint being disposed in said receiving space in said headband, said intermediate rod of said pivot joint extending into said guide hole in said headband.

3. The headphone as claimed in claim 2, wherein said headband has front and rear sides, and an inner side that interconnects said front and rear sides thereof, said guide hole in said headband extending from said inner side to said rear side of said headband.

4. The headphone as claimed in claim 2, wherein said headband includes an abutting piece, said first rod of said pivot joint abutting against said abutting piece of said headband, each of said first rod of said pivot joint and said abutting piece of said headband being made from metal.

5. The headphone as claimed in claim 4, wherein said abutting piece of said headband has an arcuate surface, said first rod of said pivot joint abutting against said arcuate surface of said abutting piece of said headband.

6. The headphone as claimed in claim 1, wherein said ear cup defines a receiving space, and is formed with a guide hole therethrough that is in spatial communication with said receiving space in said ear cup, said second rod of said pivot joint being disposed in said receiving space in said ear cup, said intermediate rod of said pivot joint extending into said guide hole in said ear cup.

7. The headphone as claimed in claim 6, wherein said ear cup includes an abutting piece, said second rod of said pivot joint abutting against said abutting piece of said ear cup, each of said second rod of said pivot joint and said abutting piece of said ear cup being made from metal.

8. The headphone as claimed in claim 7, wherein said abutting piece of said ear cup has an arcuate surface, said second rod of said pivot joint abutting against said arcuate surface of said abutting piece of said ear cup.

9. The headphone as claimed in claim 6, wherein said first rod of said pivot joint includes
a first rod portion that is formed on said intermediate rod of said pivot joint and that has a size less than that of said guide hole in said ear cup, and
a second rod portion that is fastened to said first rod portion,
said first rod of said pivot joint having opposite ends,
said intermediate rod of said pivot joint being disposed at a position between said opposite ends of said first rod of said pivot joint.

10. The headphone as claimed in claim 9, wherein said second rod portion of said first rod of said pivot joint is fastened to said first rod portion of said first rod of said pivot joint using one of an adhesive, a rivet, and a screw.

11. The headphone as claimed in claim 6, wherein said first rod and said intermediate rod of said pivot joint are formed in one piece, said first rod having a size less than that of said guide hole in said ear cup, said first rod of said pivot joint having opposite ends, said intermediate rod of said pivot joint being disposed at a position between said opposite ends of said first rod of said pivot joint.

12. The headphone as claimed in claim 1, further comprising a transmission wire unit, said intermediate rod of said pivot joint defining an axially extending channel for extension of said transmission wire unit therethrough, said pivot joint being made from metal, said first and second rods of said pivot joint being transverse to each other.

13. The headphone as claimed in claim 12, wherein each of said first and second rods of said pivot joint defines an axially extending channel that is in spatial communication with said channel in said intermediate rod of said pivot joint for extension of said transmission wire unit therethrough.

14. The headphone as claimed in claim 1, wherein said pivot joint is hollow, said headphone further comprising:
a hollow second pivot joint coupled rotatably to said headband;
a second ear cup coupled rotatably to said second pivot joint; and
a transmission wire unit extending through said pivot joint and said second pivot joint and coupled electrically to said second ear cup.
